(19) United States
(12) Patent Application Publication
(10) Pub. No.: US 2026/0132760 A1
(43) Pub. Date: May 14, 2026

(54) ADVANCED RAM SCOOP CONCEPTS FOR ROTATING DETONATION ENABLED HIGH-SPEED PROPULSION SYSTEMS

(71) Applicant: GENERAL ELECTRIC COMPANY, Evendale, OH (US)

(72) Inventors: Skye Elliott, Saratoga Springs, NY (US); Kapil Singh, Rexford, NY (US); Arin Elspeth Lastufka Cross, Waterford, NY (US); Krishnakumar Venkatesan, Clifton Park, NY (US); Shih-Yang Hsieh, Cohoes, NY (US); William Henderson, Plainview, NY (US); Samuel Gordon Cavas, New York, NY (US); Sydney Harwood, Evendale, OH (US)

(21) Appl. No.: 18/945,943

(22) Filed: Nov. 13, 2024

(51) Int. Cl. F02K 7/14

(52) U.S. Cl. CPC F02K 7/14

(57) ABSTRACT

A high-speed, air-breathing propulsion engine includes a rotating detonation combustor configured to burn a fuel-air mixture and at least one ram scoop. The at least one ram scoop is configured to separate incoming air into a core flow stream and a pilot flow stream. The at least one ramp scoop is configured to cause the separation of the core flow stream and the pilot flow stream at a location disposed within a range of locations. The engine is configured to combine the pilot flow stream and the core flow stream in the rotating detonation combustor to enable a rotating detonation wave in the rotating detonation combustor.

### TECHNICAL FIELD

This disclosure relates to aerial vehicles, and more particularly, to air-breathing propulsion systems that power aerial vehicles, such as ramjets and scramjets, with rotating detonation.

### BACKGROUND

A ramjet is a type of air-breathing jet engine that operates on the principle of ram compression. Unlike traditional jet engines, which compress air using a compressor, a ramjet relies on the forward motion of the engine itself to compress incoming air. As the air enters the ramjet's inlet, it is compressed by the engine's forward motion. Fuel is then injected into the compressed air, causing it to ignite and create a high-temperature exhaust that propels the engine forward. Depending on the vehicle mission, ramjets may have different engine flow path designs. For example, mechanically throated ramjets can provide subsonic combustion or dual mode ramjets can provide subsonic combustion at lower flight Mach numbers and supersonic combustion (e.g., scramjet) at higher flight Mach numbers. Ramjets can operate across a broader range of supersonic and hypersonic Mach numbers, but they require initial speed in order to start.

Rotating detonation engines (RDEs) take advantage of the thermodynamic properties of a more efficient combustion modality: detonation. A fuel and an oxidizer are injected into the upstream end of the detonation chamber. They are then ignited to initiate some number of rotating detonation waves. The temperature and pressure increase across the rotating shock wave is coupled to the chemical heat release of the exothermic reaction, which continuously sustains and drives the detonation wave circumferentially. The reacted gas is then discharged continuously out of the downstream end of the detonation chamber, which can be coupled to a nozzle to generate thrust.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1A is a perspective view of a high-speed vehicle in accordance with the principles of this disclosure;

FIG. 1B and 1C are schematic diagrams of exemplary propulsion engines of the high-speed vehicle of FIG. 1A;

FIG. 2 is a schematic view illustrating locations of various stations along an exemplary propulsion engine;

FIG. 3 is a schematic view illustrating the exemplary propulsion engine of FIG. 2 feeding a ram air stream into a core stream and a pilot stream, and illustrating the pilot stream feeding a stabilized rotating detonation region that interacts with the core stream in accordance with principles of this disclosure;

FIGS. 4A-4H and FIGS. 5A-5D are schematic, forward looking-aft, cross-sectional views at various stations along the propulsion engine of various capture areas that direct the ram air stream along the propulsion engine in accordance with principles of this disclosure;

FIGS. 6A-6C, 7A-7C, 8A, and 8B are schematic, side views of portions of various embodiments of the propulsion engine in accordance with principles of this disclosure;

FIG. 9 is another schematic, side view of a portion of another propulsion engine having an S-Duct inlet in accordance with principles of this disclosure;

FIG. 10 is a top view of a portion of another propulsion engine illustrating air flow through the propulsion engine in which S-Duct inlets feed an axisymmetric duct in accordance with principles of this disclosure;

FIG. 11 is a side, perspective view of the propulsion engine of FIG. 10 illustrating asymmetric pilot air stream separation conversion to a uniform pilot air stream for feeding a rotating detonation combustor in accordance with principles of this disclosure;

FIG. 12A shows schematic, forward looking, aft, cross-sectional views of various capture areas at stations along another propulsion engine in accordance with principles of this disclosure;

FIG. 12B is an exemplary flow chart illustrating air flow through the various capture areas shown in FIG. 12A;

FIG. 13A is a schematic, side view of a portion of another propulsion engine having a variable effective pilot capture area and having a flap in accordance with principles of this disclosure;

FIG. 13B is a block diagram of a controller of the propulsion engine of FIG. 13A;

FIG. 14 is a schematic, side view of a portion of another propulsion engine including a variable effective pilot capture area and having a translating ram scoop in accordance with principles of this disclosure;

FIGS. 15A and 15B are progressive views of a propulsion engine including a variable effective pilot capture area and having a bleed system that effectuates changes in boundary layer thickness upstream of a separation of pilot and core steams in accordance with principles of this disclosure;

FIG. 16 is a schematic view of another propulsion engine of a rotating detonation ramjet having a shock structure in an isolator/diffuser with a core stream and pilot stream being separated upstream of the shock structure and downstream of station (2) of the propulsion engine in accordance with principles of this disclosure;

FIG. 17 is a schematic view of a propulsion engine of a rotating detonation ramjet configured to inject pilot air into a rotating detonation region in a radially outward direction;

FIG. 18 is a schematic view of a propulsion engine of a rotating detonation ramjet configured to inject pilot air into a rotating detonation region in an axial direction;

FIG. 19 is a diagram illustrating that shock structure and position can vary for a rotating detonation dual-mode ramjet or a rotating detonation scramjet in accordance with principles of this disclosure;

FIG. 20 is a diagram showing that for a propulsion system operating in scram-mode, pilot air separation may occur downstream of fuel injection between stations 3-4; and

FIGS. 21 and 22 are schematic, side views illustrating different arrangements of propulsion engines in accordance with principles of this disclosure.

Further exemplary aspects of the disclosure are described in more detail below with reference to the appended figures. Aspects of this disclosure may be combined without departing from the scope of the disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The terms “forward” and “aft” refer to relative positions within an engine or vehicle and refer to the normal operational attitude of the engine or vehicle. For example, with regard to an engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

As used herein, the terms “first,” “second,” and “third” may be used interchangeably to distinguish one component from another and are not intended to signify location or importance of the individual components. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

Although this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the drawings, and specific language will be used to describe the same. It will nevertheless be understood that no limitation of the scope of this disclosure is thereby intended. Any alterations and further modifications of the inventive features illustrated herein, and any additional applications of the principles of this disclosure, as illustrated herein, which would occur to one skilled in the relevant art and having possession of this disclosure, are to be considered within the scope of this disclosure.

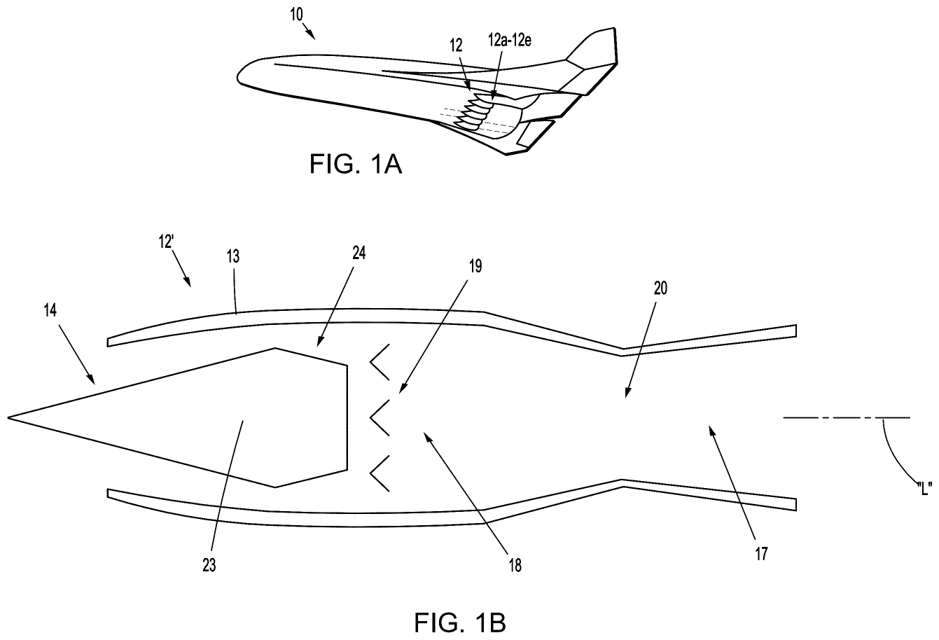

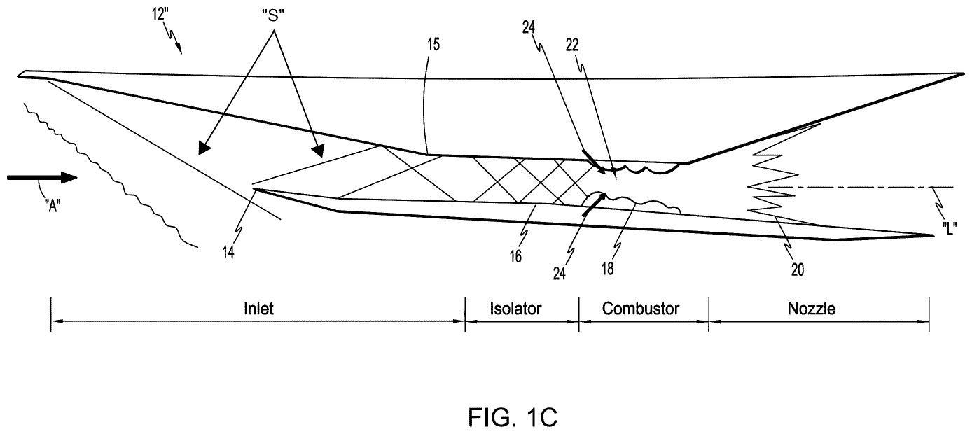

Illustrated in FIG. 1A is a perspective view of a high-speed aircraft 10 including a high speed, air-breathing propulsion engine 12, also referred to herein as a propulsion engine or an engine, which may include a plurality of separate and distinct engines (e.g., five separate ramjet or scramjet engines 12a to 12e). The number of engines is determined for particular applications of the aircraft 10 and may include less than or more than five engines 12 configured for high-speed operation.

FIG. 1B illustrates a lengthwise cross-sectional view of an exemplary ramjet engine 12′, which is an example of air-breathing propulsion engine 12 (and/or one or more of the separate ramjet and/or scramjet engines 12a to 12e). The engine 12′ includes various sections including an inlet 14, a combustor 18, and an exhaust 17 in serial flow arrangement along a lengthwise direction “L”. The engine 12′ includes a longitudinal wall 13 extended along the lengthwise direction “L.” The longitudinal wall 13 defines, at least in part, a gas flowpath of the engine 12′ around a centerbody 23 of the engine 12′. The longitudinal wall 13 is extended along the lengthwise direction “L” and contoured to define the inlet 14, the exhaust 17, the combustor 18, and a nozzle 20 of the engine 12′. Further, injectors 24 are configured to supply fuel for combustion in combustor 18. The engine 12′ further includes one or more flame-holders 19 for stabilizing and maintaining a combustion flame.

FIG. 1C is a schematic diagram of one example of a high speed, air-breathing propulsion engine 12″ of the high-speed aircraft 10 of FIG. 1A (e.g., a dual-mode ramjet) and another example of air-breathing propulsion engine 12. Engine 12″ generally has various sections that include an inlet 14, an isolator 16, a combustor 18, and a nozzle 20. Inlet 14, isolator 16, combustor 18, and nozzle 20 define a duct 22 that extends longitudinally along engine 12″ for receiving and compressing air “A.” Duct 22 defines a central longitudinal axis “L.” Engine 12 further includes fuel injectors 24 (e.g., spray bars or the like) to supply a fuel.

More specifically, inlet 14 is configured to compress, for instance via supersonic compression, the incoming atmospheric air “A” before combustion. Isolator 16 is disposed between inlet 14 and combustor 18. Isolator 16 is configured to contain pre-combustion flow disturbances formed by a pressure difference between inlet 14 and combustor 18, improve the homogeneity of the flow in combustor 18, and to extend the operating range of engine 12″. Combustor 18 is configured to burn fuel (e.g., gaseous and/or liquid) with atmospheric air to produce heat. Injectors 24 are located between combustor 18 and nozzle 20. Injectors 24 are configured to supply fuel for combustion in combustor 18. Nozzle 20 is configured to accelerate heated air to produce thrust. As seen in FIG. 3, combustor 18 can include a rotation detonation combustor (RDC) 26.

In general, the high speed, air-breathing propulsion engines of this disclosure include rotating detonation ramjet (RDRJ), rotating detonation dual-mode ramjet (RD-DMRJ), and rotating detonation scramjet (RDSJ), turbine-based combined cycle engines with a high-speed flowpath, rocket-based combined cycle engines with a high-speed flowpath, etc. The propulsion engines of this disclosure feed air ingested by a vehicle into a pilot stream and a core stream with separate inlets and/or with ram scoops that split the flow anywhere between vehicle stations 0 and 4, depending on the vehicle type and scheme. The pilot stream provides a fresh reactant mixture to a rotating detonation piloting region. The core stream will be engaged by that region to varying degrees, depending on the scheme. Active control over this pilot stream may be required during vehicle maneuvers, flight stages, etc. This is accomplished by, for example, separate pilot and core stream inlets, variable scoop geometry, and/or upstream bleed of the boundary layer to change the effective area captured by the ram scoop.

For a more detailed description of similar high-speed aircraft, one or more components of which may be included or modified for use with the disclosed aircraft 10, reference can be made to U.S. Pat. No. 5,085,048 and/or U.S. Pat. No. 11,359,578, the entire contents of each of which are incorporated by reference herein.

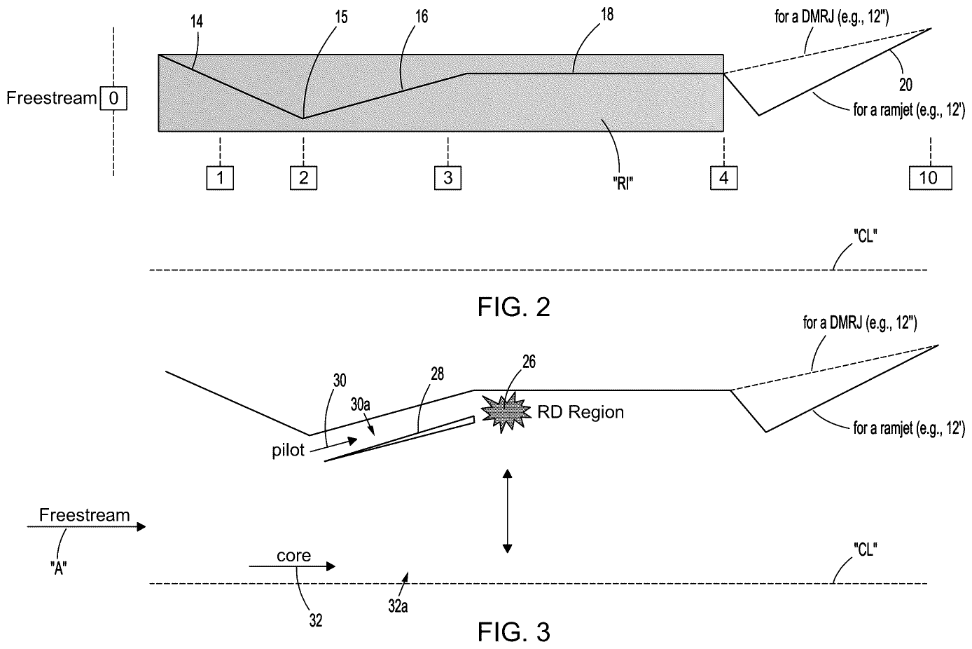

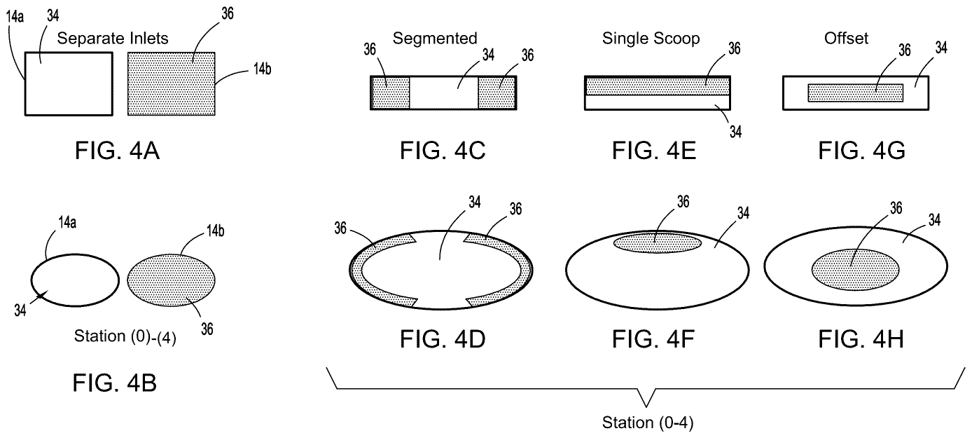

With reference to FIGS. 2 and 3, to improve upon systems relying on passive entrainment of air to deflagrative flame-holding regions, the propulsion engines of this disclosure include one or more separate inlets 14 (e.g., inlets 14a, 14b; see e.g., FIGS. 4A and 4B) and/or one or more ram scoops 28 (e.g., diffuser style) configured to decelerate air flow streams and recover total pressure (where incoming air has a high velocity but a low static pressure so the static pressure is increased toward the total pressure by virtue of the ram scoops 28). The separate inlets 14a, 14b and/or ram scoops 28 function as stream capture structures that split the incoming air “A” (e.g., an inlet ram air) stream into a pilot stream 30 and core stream 32 (which has a lower pressure than the pilot stream 30). Stated differently, the ram scoop is configured to separate incoming air into the core flow stream and the pilot flow stream so that the pilot flow stream is slowed to a higher static pressure than the core flow stream. The intent of the pilot stream 30 is to directly feed and stabilize the rotating detonation region in the RDC 26. Each of these streams have an associated requirement set for flow properties to enable a stable operation of a detonation wave by the RDC 26. Some of these parameters may be expressed as a percentage of the total incoming air flow. For example, the pilot air flow may be in the range of 0-60% of the total (incoming) air flow. This disclosure details the advantageous features of separating ram air flow and management of shape and performance of a pilot flow duct 30a and/or core flow duct 32a defined by, for example, separate inlets 14a, 14b and/or one or more ram scoops 28 to enable such ducts to meet each set of flow requirements. The separate inlets 14a, 14b and/or ram scoops 28 of this disclosure are immersed into the incoming air flow to capture a cross-sectional area of the incoming air flow.

As seen in FIG. 3, for instance, the propulsion engines of this disclosure can define a central axis or centerline “CL” that may extend through the propulsion engine and/or through one or more components thereof such as, for example, the core flow duct 32a and/or the pilot flow duct 30a.

With reference again to FIG. 2, as would be understood by persons of ordinary skill in the art and for clarity in understanding the principles of this disclosure, predetermined locations of stations of propulsion engines of this disclosure can be schematically arranged by number (e.g., stations (0) to (10). Although stations (0) to (10) are commonly understood by persons of ordinary skill in the art, in the interest of clarity, station (0) is a location of freestream or incoming air (e.g., at a forward end of inlet 14 of the propulsion engine), station (1) is a location along the inlet 14 of the propulsion engine, station (2) is a location at a minimum area 15 of the propulsion engine that separates the inlet 14 and the isolator/diffuser 16 of the propulsion engine (see also FIG. 1C above), station (3) is a location where the isolator/diffuser 16 ends and the combustor 18 of the propulsion engine begins, and station (4) is a location at an aft end of the combustor 18. Stations 0-4 define a region of interest “RI” for purposes of implementing the separate inlets 14a, 14b and/or ram scoops 28 of this disclosure to feed the RDC 26. Stations (5)-(9) (not explicitly delineated) are locations disposed between stations (4) and (10) and are not relevant for purposes of this disclosure, but station (10) is a location of the propulsion engine at an aft end of the nozzle 20. For RDRJ, the separate inlets 14a, 14b and/or ram scoops 28 can be implemented, for instance, from station (0) to station (3). For RD-DMRJ and/or RDSJ, the separate inlets 14a, 14b and/or ram scoops 28 can be implemented, for instance, from station (0) to station (4) (depending on the operating mode).

To facilitate improved pilot injection performance, the disclosed separate inlets 14a, 14b and/or ram scoops 28 are configured to separate the inlet ram air and are configured to be disposed upstream of high total pressure loss core stream pseudo-shock structures. The disclosed propulsion engines leverage shape and flow features to improve flow properties for maintaining flow directionality, injection pressure, and rotating detonation operability across a range of flight and engine operating conditions suitable for high speed, air-breathing propulsion engines. Management of shape and performance of the pilot flow duct 30a and/or the core flow duct 32a enables such ducts to meet each set of flow requirements.

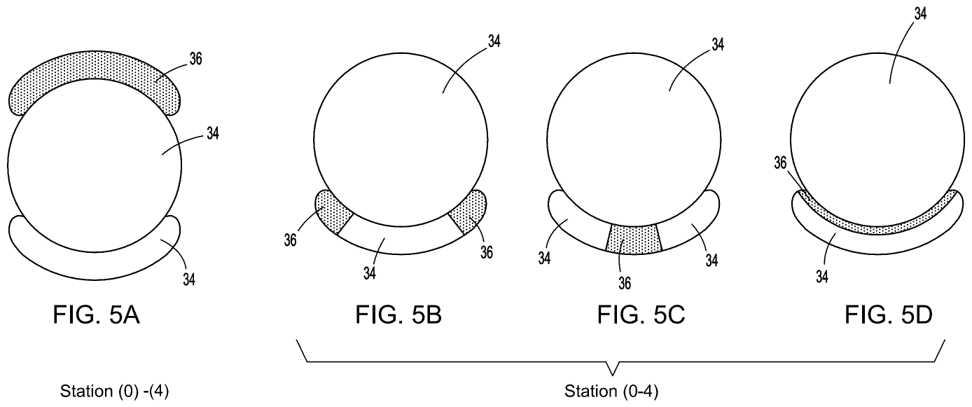

Turning now to FIGS. 4A-4H, the disclosed pilot flow ducts 30a define one or more pilot capture areas 36 and the disclosed core flow ducts 32a define one or more core capture areas 34, each of which can include any suitable shape and/or configuration at one or more of stations (0) to (4). For instance, as seen in FIG. 4A, the core capture area 34 and/or the pilot capture area 36 (and/or the respective ducts 30a, 32a) can include separate inlets 14a, 14b at station (0) which may be, for instance, rectangular as shown in FIG. 4A and/or annular (e.g., elliptical) as shown in FIG. 4b. Indeed, at one or more any of stations (0) to (4), the core capture area 34 and/or the pilot capture area 36 (and/or the respective ducts 30a, 32a) may be segmented (as seen in FIGS. 4C and 4d), single scoop (as seen in FIGS. 4E and 4F), offset (as seen in FIGS. 4G and 4H), and/or combinations thereof. Additionally, and/or alternatively, at one or more of any of stations (0) to (4), the core capture area 34 and/or the pilot capture area 36 (and/or the respective ducts 30a, 32a) may be in the form of a chin inlet configuration as seen in the exemplary drawings shown in FIGS. 5A-5D. Indeed, one or more of these capture areas may stay the same and/or change along the lengths (or portions thereof) of the disclosed inlets and/or ducts from station (0) to station (4).

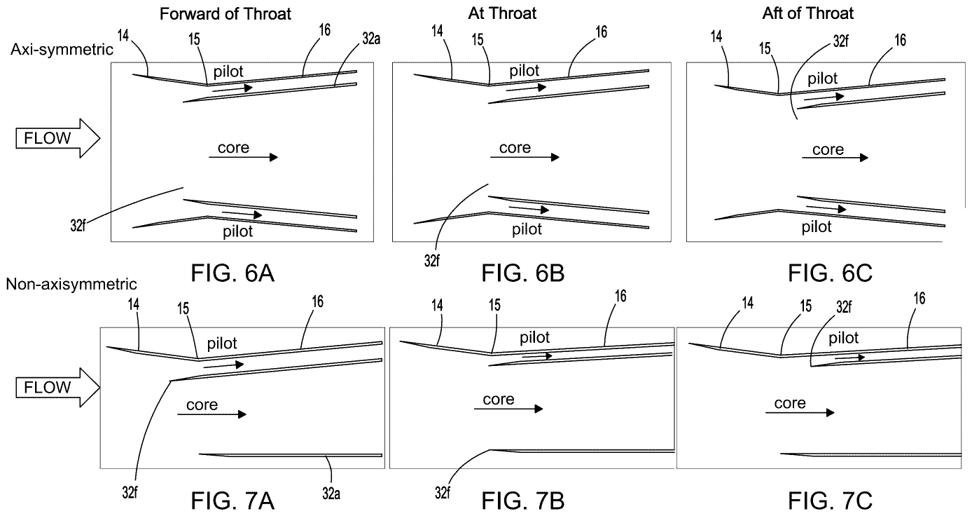

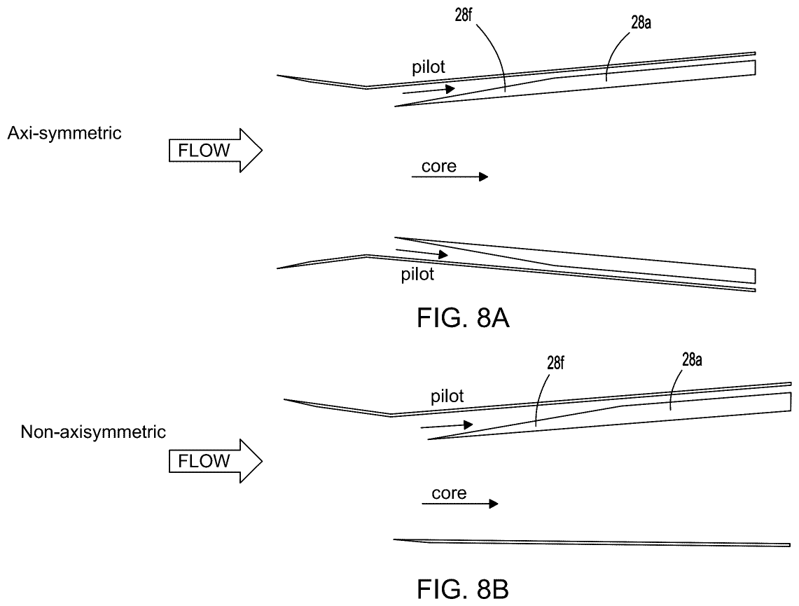

With reference to FIGS. 6A-8B, although the disclosed pilot and/or core flow ducts 30a, 32a and/or respective pilot and/or core capture areas 34, 36 can have any suitable shape or configuration as noted above, only annular (e.g., FIGS. 6A-6C and 8A: axi-symmetric, for example relative to centerline “CL”: see FIG. 2) and rectangular (e.g., FIGS. 7A-7C and 8B: non-axisymmetric) arrangements are illustrated in the interest of brevity. Notably, as used herein, axisymmetric means that a shape, object, or system is symmetric around a central axis and/or centerline such as centerline “CL,” whereas, non-axisymmetric means that a shape, object, or system is not symmetric around a central axis and/or centerline such as centerline “CL.” As seen in FIGS. 6A and 7A, for example, a forward end 32f of the core flow duct 32a (which may define one or more of the inlets 14a, 14b) can be disposed forward or distal of the throat 15 of the propulsion engine. In aspects, as seen in FIGS. 6B and 7B, for example, the forward end 32f of the core flow duct 32a can be disposed at (e.g., in longitudinal alignment with) the throat 15. In certain aspects, as seen in FIGS. 6C and 7C, for example, the forward end 32f of the core flow duct 32a can be disposed aft or proximal of the throat 15.

As seen in FIGS. 8A and 8B, the ram scoops 28 of the disclosed propulsion engines can include one or more portions or segments with the same, different, and/or changing profiles. For instance, ram scoop 28 can include a forward profile 28f and an aft profile 28a that function to further separate the pilot and core streams to accommodate other engine features and/or change the speed, acceleration, and/or pressure of the air flow of the pilot and/or core streams through the respective pilot and/or core flow ducts 30a, 32a (see FIG. 3). In aspects, the forward profile 28f may increase in thickness from the forward end to the aft end of the forward profile 28f (e.g., gradually taper) to reduce the capture area of the pilot flow duct 30a to increase air flow pressure, for instance. In certain aspects, the thickness (e.g., in the radial direction) along the length of the ram scoop 28 may decrease, increase, and/or stay the same along one or more lengths of the ram scoop 28 to facilitate air flow through the pilot and/or core flow ducts 30a, 32a and to separate a distance between the core flow stream and the pilot flow stream. In some aspects, the profile of the ram scoop 28 (defined by outer walls of the ram scoop 28) may be configured to provide a Venturi effect at one or more locations along the length thereof. In certain aspects, the size and/or shape of one or more of the ducts and/or capture areas may be actively and/or passively changed, which can depend on the state or flight stage of the propulsion engine (e.g., taxi, takeoff, cruise, landing, speed, acceleration, and/or during predetermined flight maneuvering such as a predetermined yaw, pitch, and/or roll and/or angle-of-attack) and/or flight conditions (e.g., temperature, altitude, pressure, etc.).

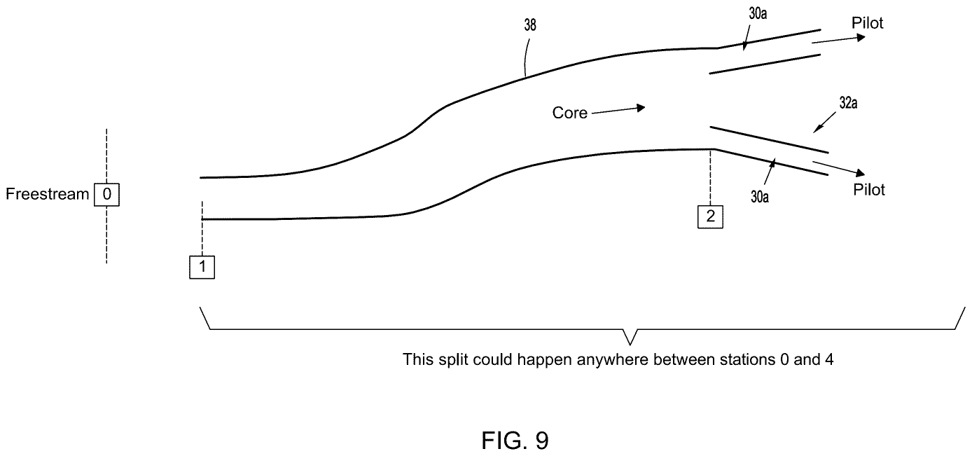

With reference to FIG. 9, in some aspects, the propulsion engines of this disclosure can include an S-Duct inlet 38 that splits into one or more pilot flow ducts 30a and one or more core flow ducts 32a anywhere from station (0) to station (4). In aspects of this disclosure, the S-Duct inlets are configured to direct the incoming air from a forward location to an aft location along the engine. Notably, an S-Duct inlet is an air intake system with an S-shaped curve that directs airflow to the engine. S-Duct inlets are configured to be used in designs where the engine is not mounted directly in line with the aircraft's centerline. The S-duct enables air to be channeled smoothly into the engine, even if the engine is located in an unconventional position, like in the fuselage or near a tail of the aircraft.

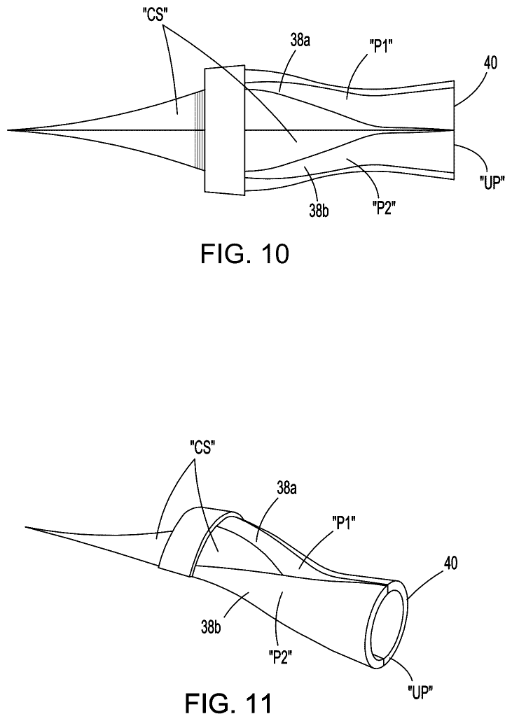

As seen in FIGS. 10 and 11, in one aspect, S-Duct inlets 38a, 38b feed into an axisymmetric duct 40. In such aspect, asymmetric pilot air streams “P1” and “P2” flowing through these S-Duct inlets 38a, 38b extend around a core stream “CS” and converge to a uniform pilot air stream “UP” in the axisymmetric duct 40 for feeding the RDC 26 (see FIG. 2).

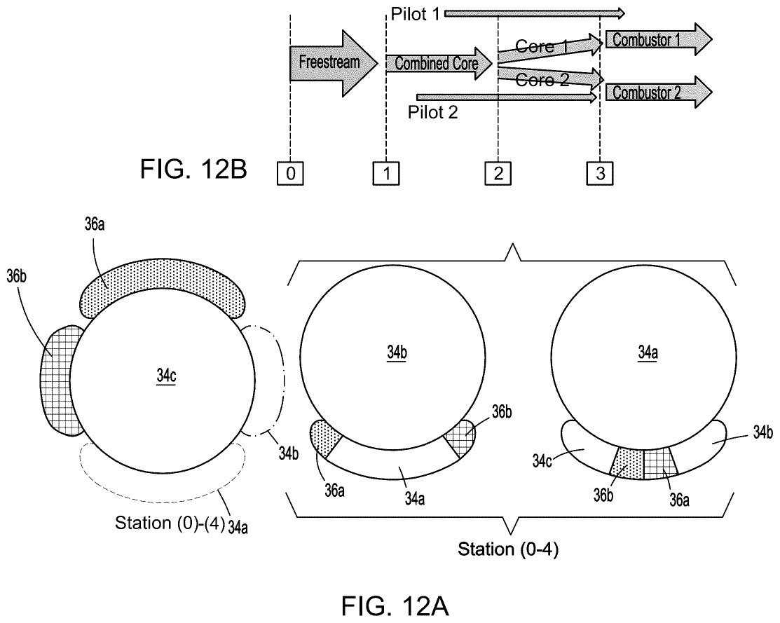

Turning now to FIGS. 12A and 12B, in aspects, the propulsion engines of this disclosure can include multiple core and/or pilot capture areas for capturing air streams, and which may include multiple inlets, a single inlet with different flowpath splits (as seen in FIG. 12B), and/or any other suitable combination. For instance, as seen in FIG. 12A, the propulsion engines can include any number and/or arrangement of capture areas such as a first core capture area 34a, a second core capture area 34b, a third capture area 34c, etc., and/or a first pilot capture area 36a, a second core capture area 36b, etc., each of which can have any suitable shape and/or configuration. Indeed, similar to other embodiments detailed herein, one or more of these capture areas may stay the same and/or change along the lengths (or portions thereof) of the disclosed inlets and/or ducts from station (0) to station (4).

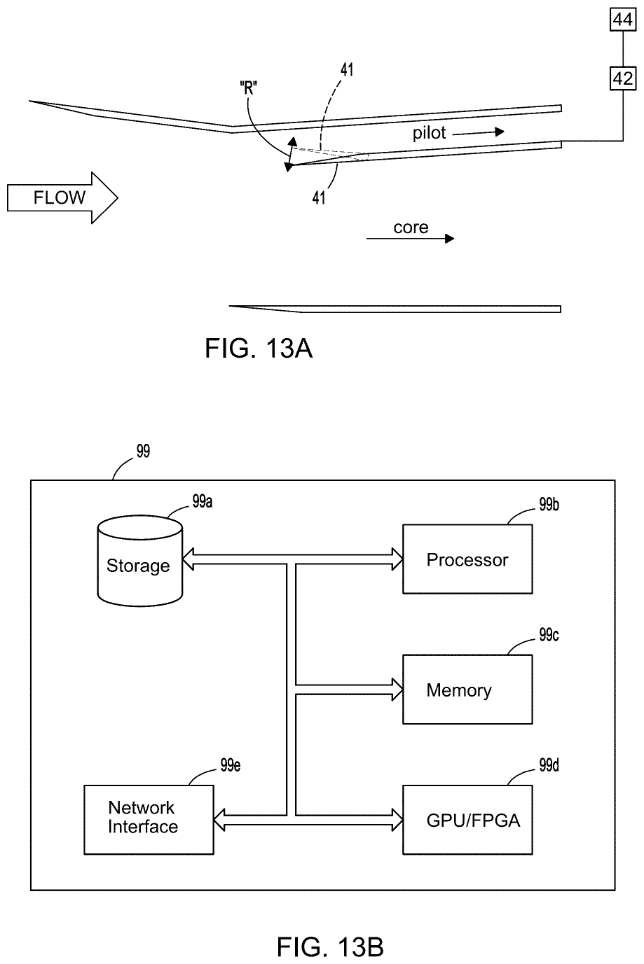

With reference to FIG. 13A, in some aspects, the ram scoop can include one or more rotating flaps 41 pivotably coupled to a forward end of the ram scoop, as indicated by arrows “R,” to change an amount of air flow feeding into the pilot and/or the core flow ducts and to improve air flow based on flight conditions and/or the state of the propulsion engine as noted above. Indeed, the system may require the ability to vary the effective pilot capture area. For example, different mass flow splits may be required at different flight conditions, there may be throttling of the pilot air flow required for acceleration conditions but limited or no throttling involved for cruise conditions, the Mach number may vary at an inlet of the ram scoop which may affect performance, and/or there may be vehicle maneuvers/angle-of-attack changes that may affect an ingested boundary layer thickness.

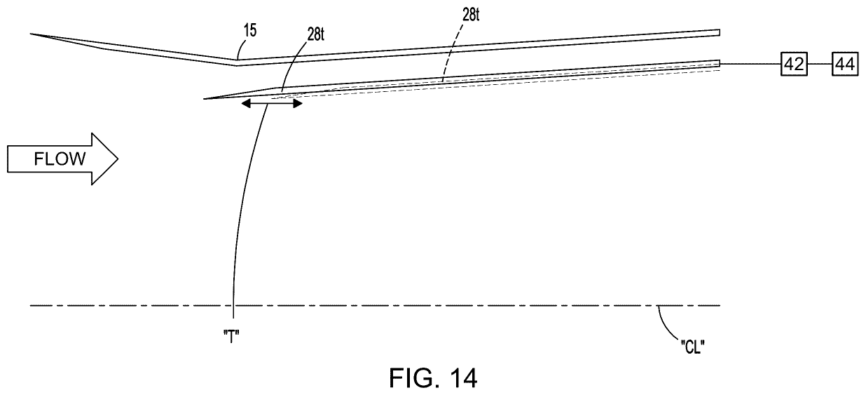

As seen in FIG. 14, in certain aspects, a ram scoop 28t can be configured to actively and/or passively translate in a longitudinal direction relative to the throat 15, as indicated by arrows “T” (e.g., relative to the centerline in at least one of a forward and/or aft direction).

In a passive system, movement of the flap 41 (see FIG. 13A) and/or ram scoop 28t (see FIG. 14) may be controlled, for example, by one or more springs or dampers that may be, for example, compressed and/or extended based on velocity of the vehicle and/or pressure of the air flow.

In an active system, for example, the flap 41 and/or the ram scoop 28t can be coupled to any suitable drive assembly 42 that is configured to rotate flap 41 and/or translate the ram scoop 28t. The drive assembly 42 can include any suitable electrical and/or mechanical structure for effectuating selective rotation of flap 41 to any number of positions and/or for disposing flap 41 at any suitable angle (e.g., an acute angle) relative to the centerline “CL” and/or relative to an aft end of the ram scoop 28t. Similarly, the drive assembly 42 can include any suitable electrical and/or mechanical structure for effectuating selective translation of the ram scoop 28t along the centerline “CL.” As can be appreciated, the drive assembly 42 can include, for example, gearing, motors, pulleys, cables, lead screws, circuity, etc. for effectuating such rotation of the flap 41 and/or translation of the ram scoop 28t (or portions thereof). The drive assembly 42 can include and/or be operatively coupled to a wired or wirelessly connected controller 44, which may include or be operatively coupled to a control system 99 of high-speed aircraft 10 and/or high speed, air-breathing propulsion engine such as engines 12, 12′, and/or 12″.

With brief reference to FIG. 13B, exemplary components of the control system 99 and/or controller 44 include, for example, a database 99a, one or more processors 99b, at least one memory 99c, and a network interface 99e. In aspects, the control system 99 may include a graphical processing unit (GPU) 99d, which may be used for processing machine learning network models. Various components of the control system 99 may be utilized to execute instructions to perform the various operations of the propulsion engines of this disclosure. Further, the controller 99 may include communication circuitry capable of wired or wireless communication to receive data from other devices.

Indeed, as used herein, the term “control system” or the like includes a “controller,” “processor,” “digital processing device” and like terms, and can include a component configured or adapted to provide instruction, control, operation, or any form of communication for operable components to affect the operation thereof. A controller can include any known processor, microcontroller, or logic device, including, but not limited to: field programmable gate arrays (FPGA), an application specific integrated circuit (ASIC), a full authority digital engine control (FADEC), a proportional controller (P), a proportional integral controller (PI), a proportional derivative controller (PD), a proportional integral derivative controller (PID controller), proportional resonant controller (PR), a hardware-accelerated logic controller (e.g. for encoding, decoding, transcoding, etc.), the like, or a combination thereof. Non-limiting examples of a controller can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types. In another non-limiting example, a controller can also include a data storage component accessible by the processor, including memory, whether transient, volatile or non-transient, or non-volatile memory that includes instructions which are executable by the processor.

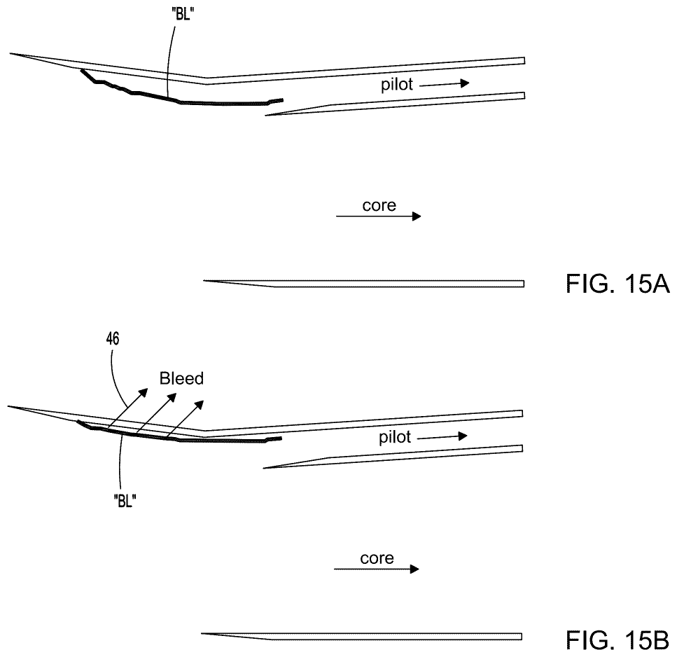

As seen in FIGS. 15A and 15B, the propulsion engines of this disclosure can include an upstream bleed system 46 configured to change (e.g., reduce) a thickness of a boundary layer “BL” for varying the effective pilot capture area. Additionally, and/or alternatively, the ratio of boundary layer thickness to pilot freestream height can also be actively controlled by rotating flap 41 and/or translating the ram scoop 28 as detailed above.

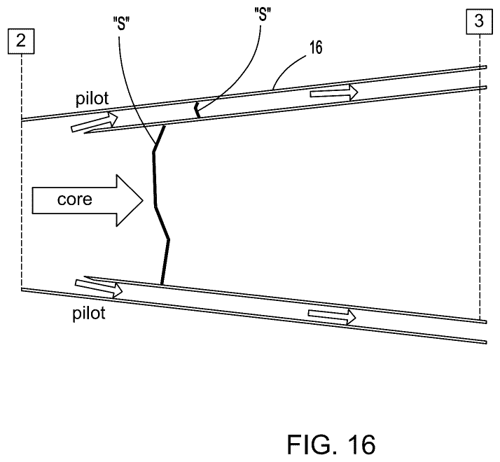

With reference to FIGS. 16-18, for an RDRJ system with a shock structure “S,” for instance, the pilot and core flow streams are configured to be separated at one or more locations from station (0) to station (3) to improve performance.

Notably, as used herein, in a jet engine, especially in supersonic and high-speed designs, the shock structure refers to the series of shock waves and expansion waves that form to slow down, compress, and manage the airflow as it enters the engine. In jet engines, particularly for supersonic flight, the air must be slowed to subsonic speeds before entering the combustion chamber to ensure stable combustion and efficient operation. Properly structured shocks allow the engine to maintain high levels of efficiency, prevent engine stalls, and manage airflow temperature and pressure before combustion. Without effective shock structure management, the engine would experience turbulence, airflow instability, and potential performance loss or failure at high speeds. The two main types of shock waves involved are normal and oblique shocks. Normal shocks, which occur perpendicular to the airflow, cause a sudden drop in air velocity and an increase in pressure and temperature. These typically form in front of the engine intake or within the intake system itself. In contrast, oblique shocks, which are angled relative to the airflow, occur in a series of stages to gradually slow and compress the incoming air with less abrupt pressure changes, making them more efficient and suitable for high-speed engines.

Additionally, many supersonic engines employ mixed compression systems, a combination of internal and external compression, to create a more intricate shock structure both outside and inside the engine intake. This approach optimizes the deceleration and pressure increase of the airflow with minimal energy loss, ensuring efficient performance at high speeds and maintaining stable airflow through the engine.

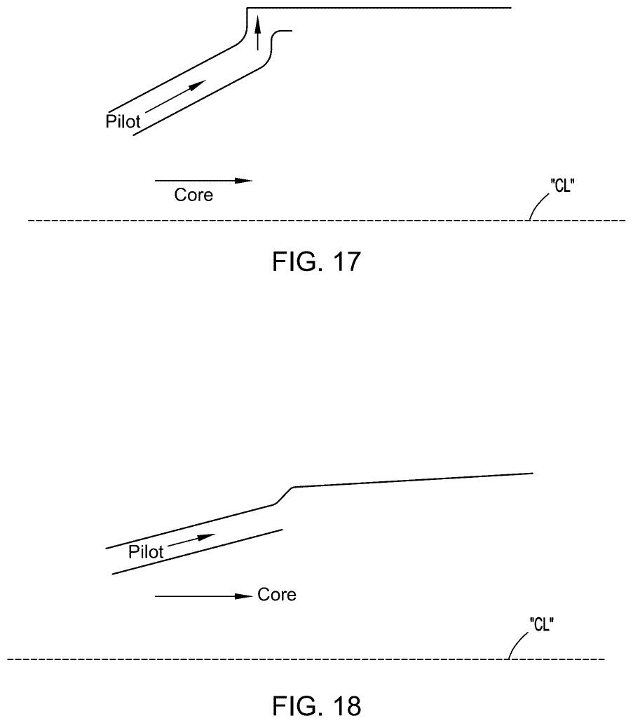

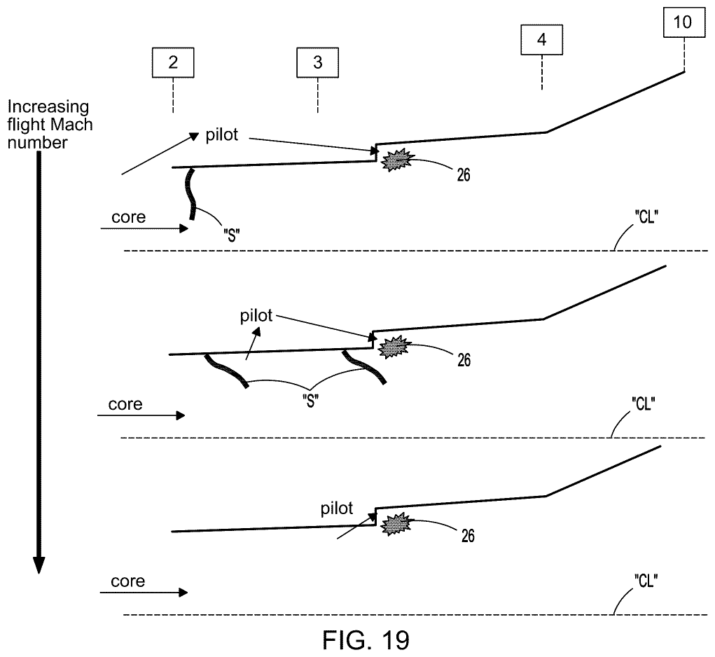

In aspects of this disclosure, when the shock structure “S” is in the isolator/diffuser 16, the pilot and core flow streams are separated upstream of the shock structure “S” such as just downstream of station (2) as shown in FIG. 16. The flow streams can then be reintroduced in a variety of ways. For instance, as shown in FIG. 17, the pilot flow stream can be injected radially outward into the RDC (see e.g., RDC 26 in FIG. 19). Alternatively, as seen in FIG. 18, the pilot flow stream can be injected axially into the RDC. In any of these aspects, the flowpaths of these core and pilot flow streams can be fueled in a variety of different ways. For instance, any suitable fuel injection technique can be provided such as one or more of the following types of fuel injectors: direction, angle, immersion into flow path; co-and counter-swirling injectors; singlet, doublet, quad-impinging injectors, and/or slots.

Turning now to FIG. 19, in a RD-DMRJ/RDSJ, for instance, the shock structure “S” and position can vary from a position near station (2) to not being present at all. This means that the pilot and core flow streams can be split from stations (0) to (4). If targeting lower flight Mach numbers (e.g., Mach 1 to Mach 3), the pilot and core flow streams are split upstream of the shock structures “S” to leverage a static to total pressure difference (e.g., such as when there is a supersonic inflow for leveraging the high velocity air). If targeting intermediate flight Mach numbers (e.g., Mach 4 to Mach 6), the pilot and core flow streams could be separated in the middle of an oblique shock train or in the combustor while still providing sufficient injection pressure. If targeting higher flight Mach numbers (e.g., Mach 7 or higher) where no pre-combustion shock is present, the pilot and core flow streams can be split and reintroduced anywhere in the propulsion engine.

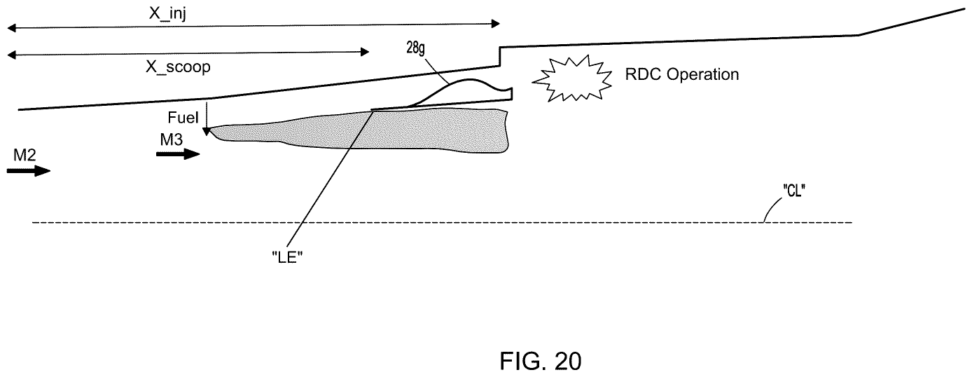

With reference to FIG. 20, in a RD-DMRJ/RDSJ, for instance, an axial position along centerline “CL” of a leading end “LE” of a ram scoop 28g be varied, as indicated by “X_scoop” for changing the pilot flow stream to account for different conditions and/or circumstances as detailed above (e.g., state of the propulsion engine and/or flight conditions). As can be appreciated, the leading end “LE” can be moved via a drive assembly (e.g., drive assembly 42 shown in FIG. 14) and/or the engine can be designed with the leading end “LE” positioned at any suitable axial location along the centerline “CL”. Similarly, an inlet and diffuser shape of the ram scoop 28g can also be varied, the air may be injected axially or radially out of the pilot air stream into the core flow stream and/or RDC as detailed above, and the axial location of such injection can be varied via drive assembly and/or different position as noted above, and as indicated by “X_inj.” The fueling schemes about the ram scoop may also be varied. For example, penetration of a core stage may be arranged to avoid fuel entrainment and parasitic deflagration in ram scoops at favorable conditions or to pre-mix the fuel through ram scoops at harsh conditions. FIG. 20 shows an example of the ram scoop being positioned radially outboard at a position adjacent to the outer diameter to avoid entraining upstream fuel into the pilot air stream which may be entering at Mach 2 (“M2”) or Mach 3 (“M3”) speeds. The shaded areas indicate the fuel distribution, which penetrates the core but does not enter the pilot air stream through the ram scoops. This avoids premature combustion in the pilot air stream, which would decrease the amount of available oxygen for detonation. However, when it is beneficial to premix the fuel in the ram scoop to promote detonation, the fuel injection in the core (e.g., upstream of the ram scoop), can be configured to deliberately entrain fuel into the pilot air stream.

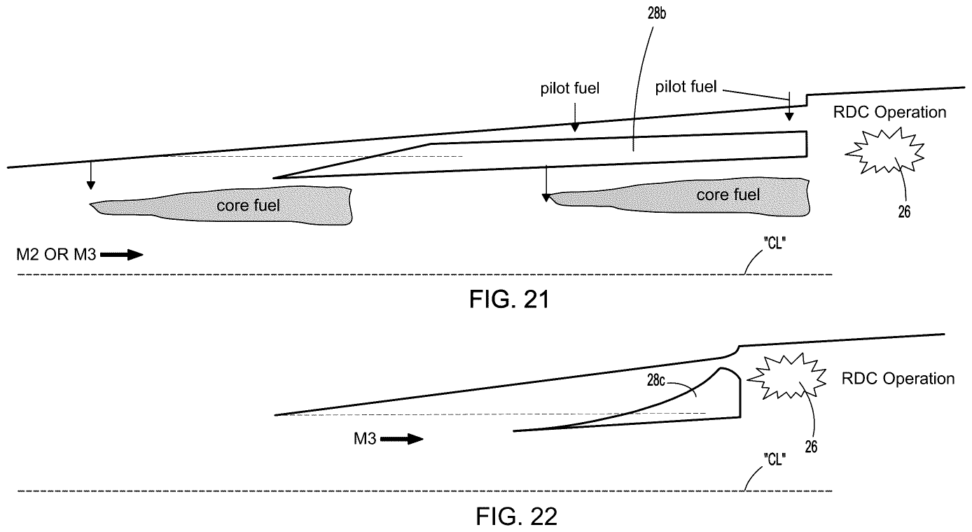

Turning now to FIG. 21 and FIG. 22, in a RD-DMRJ/RDSJ, for instance, the geometries of the ram scoop 28 can also be varied (see e.g., ram scoop 28b and ram scoop 28c). For instance, the scoop geometries can include a capture to throat area ratio, and a throat to injection area ratio, configured to compress and choke supersonic inflow under backpressure from combustion and diffuse the inflow towards the RDC 26 further recovering total pressure. The pilot capture area to total flow area may be in the range of 0-60% and the pilot capture to pilot throat area would depend on the incoming Mach number range to the ram scoop to provide sufficient deceleration of the flow without unstart of the ram scoop.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ this disclosure in virtually any appropriately detailed structure.

The phrases “in an aspect,” “in aspects,” “in various aspects,” “in some aspects,” “in other aspects,” or the like, may each refer to one or more of the same or different aspects in accordance with this disclosure.

Further aspects of the present disclosure are provided by the subject matter of the following clauses.

A high-speed, air-breathing propulsion engine, the engine comprising a rotating detonation combustor and at least one ram scoop. The rotating detonation combustor is configured to burn a fuel-air mixture and is disposed in a combustor section of the engine. The at least one ram scoop is configured to separate incoming air into a core flow stream and a pilot flow stream. The at least one ramp scoop is configured to cause the separation of the core flow stream and the pilot flow stream at a location disposed within a range of locations from a forward end of an inlet of the engine to an aft end of the combustor section of the engine. The engine is configured to combine the pilot flow stream and the core flow stream in the rotating detonation combustor to enable a rotating detonation wave in the rotating detonation combustor.

The engine of the preceding clause, wherein a forward end of the at least one ram scoop is disposed at or forward of a throat of the engine.

The engine of any of the preceding clauses, wherein the engine defines a centerline and wherein the at least one ram scoop is movable relative to the centerline to change an amount of the incoming air entering at least one of the pilot flow stream or the core flow stream.

The engine of any of the preceding clauses, wherein the at least one ram scoop includes a rotatable flap that changes the amount of incoming air entering the at least one of the pilot flow stream or the core flow stream.

The engine of any of the preceding clauses, wherein the rotatable flap is disposed on a forward end of the at least one ram scoop.

The engine of any of the preceding clauses, wherein the at least one ram scoop is configured to translate relative to the centerline in at least one of a forward direction or an aft direction.

The engine of any of the preceding clauses, wherein the at least one ram scoop changes thickness along a length of the at least one ram scoop to separate a distance between the core flow stream and the pilot flow stream.

The engine of any of the preceding clauses, further comprising at least one S-Duct inlet configured to direct the incoming air from a forward location to an aft location along the engine.

The engine of any of the preceding clauses, wherein the at least one S-Duct inlet is configured to feed into an axisymmetric duct that feeds into the rotating detonation combustor.

The engine of any of the preceding clauses, wherein at least one of the pilot flow stream or the core flow stream includes different flow path splits.

The engine of any of the preceding clauses, further comprising a bleed system disposed upstream of the at least one ram scoop, the bleed system configured to change a thickness of a boundary layer.

A high-speed, air-breathing propulsion engine, the engine comprising a rotating detonation combustor, a core flow duct, and a pilot flow duct. The rotating detonation combustor is configured to burn a fuel-air mixture. The core flow duct is configured to direct a core flow stream toward the rotating detonation combustor. The pilot flow duct is configured to direct a pilot flow stream toward the rotating detonation combustor such that the pilot flow stream enables a rotating detonation wave in the rotating detonation combustor so that the rotating detonation wave enabled by the pilot flow stream penetrates the core flow stream.

The engine of the preceding clause, further comprising at least one ram scoop configured to separate incoming air into the core flow stream and the pilot flow stream so that the pilot flow stream is slowed to a higher static pressure than the core flow stream.

The engine of any of the preceding clauses, wherein the at least one ram scoop is disposed upstream of core flow pseudo-shock structures formed in the engine.

The engine of any of the preceding clauses, wherein the core flow duct defines a core capture area and the pilot flow duct defines a pilot capture area, the core capture area and the pilot capture area arranged in a chin inlet configuration.

The engine of any of the preceding clauses, wherein the core flow duct defines a core capture area and the pilot flow duct defines a pilot capture area, wherein the core capture area and the pilot capture area have at least one of a segmented arrangement, a single scoop arrangement, or an offset arrangement.

The engine of any of the preceding clauses, wherein the pilot flow stream is injected axially into the rotating detonation combustor.

The engine of any of the preceding clauses, wherein the pilot flow stream is injected radially into the rotating detonation combustor.

A ramjet, a dual-mode ramjet, a scramjet, a turbine-based combined cycle engine, or a rocket-based combined cycle engine including the engine of any of the preceding clauses.

A high-speed, air-breathing propulsion engine, the engine comprising a rotating detonation combustor, a first inlet, and a second inlet. The rotating detonation combustor is configured to burn a fuel-air mixture. The first inlet defines a core flow duct configured to compress a first cross-section of incoming air into a core flow stream and direct the core flow stream toward the rotating detonation combustor. The second inlet defines a pilot flow duct configured to compress a second cross-section of incoming air into a pilot flow stream and direct the pilot flow stream toward the rotating detonation combustor such that the rotating detonation combustor is configured to combine the pilot flow stream and the core flow stream to stabilize a rotating detonation wave in the rotating detonation combustor.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications may be effected by one skilled in the art without departing from the scope or spirit of the disclosure. Additionally, the elements and features shown or described in connection with certain aspects may be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed is:

1. A high-speed, air-breathing propulsion engine, the engine comprising:
a rotating detonation combustor configured to burn a fuel-air mixture and disposed in a combustor section of the engine; and
at least one ram scoop configured to separate incoming air into a core flow stream and a pilot flow stream, the at least one ramp scoop configured to cause the separation of the core flow stream and the pilot flow stream at a location disposed within a range of locations from a forward end of an inlet of the engine to an aft end of the combustor section of the engine,
wherein the engine is configured to combine the pilot flow stream and the core flow stream in the rotating detonation combustor to enable a rotating detonation wave in the rotating detonation combustor.

2. The engine of claim 1, wherein a forward end of the at least one ram scoop is disposed at or forward of a throat of the engine.

3. The engine of claim 1, wherein the engine defines a centerline and wherein the at least one ram scoop is movable relative to the centerline to change an amount of the incoming air entering at least one of the pilot flow stream or the core flow stream.

4. The engine of claim 3, wherein the at least one ram scoop includes a rotatable flap that changes the amount of incoming air entering the at least one of the pilot flow stream or the core flow stream.

5. The engine of claim 4, wherein the rotatable flap is disposed on a forward end of the at least one ram scoop.

6. The engine of claim 3, wherein the at least one ram scoop is configured to translate relative to the centerline in at least one of a forward direction or an aft direction.

7. The engine of claim 1, wherein the at least one ram scoop changes thickness along a length of the at least one ram scoop to separate a distance between the core flow stream and the pilot flow stream.

8. The engine of claim 1, further comprising at least one S-Duct inlet configured to direct the incoming air from a forward location to an aft location along the engine.

9. The engine of claim 8, wherein the at least one S-Duct inlet is configured to feed into an axisymmetric duct that feeds into the rotating detonation combustor.

10. The engine of claim 1, wherein at least one of the pilot flow stream or the core flow stream include different flowpath splits.

11. The engine of claim 1, further comprising a bleed system disposed upstream of the at least one ram scoop, the bleed system configured to change a thickness of a boundary layer.

12. A high-speed, air-breathing propulsion engine, the engine comprising:
a rotating detonation combustor configured to burn a fuel-air mixture;
a core flow duct configured to direct a core flow stream toward the rotating detonation combustor; and
a pilot flow duct configured to direct a pilot flow stream toward the rotating detonation combustor such that the pilot flow stream enables a rotating detonation wave in the rotating detonation combustor so that the rotating detonation wave enabled by the pilot flow stream penetrates the core flow stream.

13. The engine of claim 12, further comprising at least one ram scoop configured to separate incoming air into the core flow stream and the pilot flow stream so that the pilot flow stream is slowed to a higher static pressure than the core flow stream.

14. The engine of claim 13, wherein the at least one ram scoop is disposed upstream of core flow pseudo-shock structures formed in the engine.

15. The engine of claim 12, wherein the core flow duct defines a core capture area and the pilot flow duct defines a pilot capture area, the core capture area and the pilot capture area arranged in a chin inlet configuration.

16. The engine of claim 12, wherein the core flow duct defines a core capture area and the pilot flow duct defines a pilot capture area, wherein the core capture area and the pilot capture area have at least one of a segmented arrangement, a single scoop arrangement, or an offset arrangement.

17. The engine of claim 12, wherein the pilot flow stream is injected axially into the rotating detonation combustor.

18. The engine of claim 12, wherein the pilot flow stream is injected radially into the rotating detonation combustor.

19. A ramjet, a dual-mode ramjet, a scramjet, a turbine-based combined cycle engine, or a rocket-based combined cycle engine including the engine of claim 12.

20. A high-speed, air-breathing propulsion engine, the engine comprising:
a rotating detonation combustor configured to burn a fuel-air mixture;
a first inlet defining a core flow duct configured to compress a first cross-section of incoming air into a core flow stream and direct the core flow stream toward the rotating detonation combustor; and
a second inlet defining a pilot flow duct configured to compress a second cross-section of incoming air into a pilot flow stream and direct the pilot flow stream toward the rotating detonation combustor such that the rotating detonation combustor is configured to combine the pilot flow stream and the core flow stream to stabilize a rotating detonation wave in the rotating detonation combustor.
